(19) United States
(12) Patent Application Publication
(10) Pub. No.: US 2016/0122532 A1
(43) Pub. Date: May 5, 2016

(54) THERMOPLASTIC RESIN COMPOSITION, MOLDED ARTICLE MADE THEREFROM, AND METHOD OF PREPARING THE THERMOPLASTIC RESIN COMPOSITION

(71) Applicants: Samsung Electronics Co., Ltd., Suwon-si (KR); Seoul National University R&DB Foundation, Seoul (KR)

(72) Inventors: Chansu Kim, Seoul (KR); Jongchan Lee, Seoul (KR); Minyoung Lim, Daejeon (KR); Namsoo Park, Suwon-si (KR); Kwangmyung Cho, Seongnam-si (KR)

(21) Appl. No.: 14/933,926

(22) Filed: Nov. 5, 2015

(30) Foreign Application Priority Data
Nov. 5, 2014 (KR) 10-2014-0152863

(51) Int. Cl. C08L 67/04; C08J 5/00

(52) U.S. Cl. CPC C08L 67/04; C08J 5/00; C08L 2207/04; C08L 2205/025; C08J 2367/04; C08J 2467/04

(57) ABSTRACT

A thermoplastic resin composition, a molded article made therefrom, and a method of preparing the thermoplastic resin composition are provided. The thermoplastic resin composition includes: a first thermoplastic polymer; and an organic-inorganic composite including a carbonaceous core and a second thermoplastic polymer grafted onto the carbonaceous core, wherein a structural unit of the first thermoplastic polymer and a structural unit of the second thermoplastic polymer are stereoisomers or have different structures.

### RELATED APPLICATIONS

This application claims the benefit of Korean Patent Application No. 10-2014-0152863, filed on Nov. 5, 2014, in the Korean Intellectual Property Office, the entire disclosure of which is hereby incorporated by reference.

### BACKGROUND

1. Field

The present disclosure relates to a thermoplastic resin composition, a molded article made of the thermoplastic resin composition, and a method of preparing the thermoplastic resin composition.

2. Description of the Related Art

There is an increasing concern about biodegradable resins such as aliphatic polyester in the aspect of environmental protection. Polylactic acid (or polylactide) is a biodegradable resin having a melting point of about 150° C. to 180° C. and good transparency. Lactic acid as a source material of polylactic acid is available from renewable sources such as plants. Since degradation products of polylactic acid, including lactic acid, carbon dioxide, and water, are harmless to the human body, the polylactic acid may have various uses such as in medical products.

Polylactic acid has good transparency and strong stiffness, but is brittle due to its poor elasticity. Therefore, polylactic acid needs to be improved in tensile characteristics.

To improve tensile characteristics of polylactic acid, a low-molecular weight organic compound or inorganic particles may be added to polylactic acid. Although adding poly-D-lactic acid or inorganic particles to poly-L-lactic acid does not seriously damage tensile strength, it results in still unsatisfactory tensile characteristics with less than 10% of strain.

Therefore, there is a need for a method of improving both tensile strength and strain of polylactic acid.

### SUMMARY

Provided is a thermoplastic resin composition comprising a first thermoplastic polymer; and an organic-inorganic composite comprising a carbonaceous core and a second thermoplastic polymer grafted onto the carbonaceous core, wherein a structural unit of the first thermoplastic polymer and a structural unit of the second thermoplastic polymer are stereoisomers. Also provided is a molded article comprising the thermoplastic resin composition, as well as a method of making a molded article by molding the thermoplactic resin composition into a desired shape.

Further provided is a method of preparing the thermoplastic resin composition. The method comprises mixing graphene oxide and D-lactide in the presence of a catalyst to prepare an organic-inorganic composite; and mixing the organic-inorganic composite and a poly-L-lactic acid to form a thermoplastic resin composition.

Additional aspects will be set forth in part in the description which follows and, in part, will be apparent from the description, or may be learned by practice of the presented embodiments.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic illustration of a method of preparing an organic-inorganic composite particle according to an embodiment of the present disclosure;

FIG. 2 is a graph illustrating the results of thermogravimetric analysis (TGA) on an organic-inorganic composite of Preparation Example 4 obtained by grafting poly-D-lactic acid onto graphene oxide; and

FIG. 3 is a graph illustrating the results of tensile characteristic evaluation on thermoplastic resin compositions of Examples 1 and 2 and Comparative Examples 1, 2, and 4.

### DETAILED DESCRIPTION

Reference will now be made in detail to embodiments of a thermoplastic resin composition, a molded article made of the thermoplastic resin composition, and a method of preparing the thermoplastic resin composition. The present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

As used herein, the term “comprising”, “comprise,” “includes,” “include,” “including”, or “containing” refers to including target components or ingredients without limitations in any embodiments, not excluding additional components or ingredients.

As used herein, “lactide” may include L-lactide consisting of L-lactic acid, D-lactide consisting of D-lactic acid, and meso-lactide consisting of L-lactic acid and D-lactic acid.

As used herein, “polylactic acid” refers to any polymer including a repeating unit formed by ring opening polymerization of lactide monomers or direct polymerization of lactic acid, for example, a single polymer or a copolymer, and is not limited to specific forms of polymers. For example, “polylactic acid” may include any of a variety of polymers in any forms, including a polymer unpurified or purified after ring opening polymerization, a polymer in a liquid or solid resin composition.

As used herein, “poly-L-lactic acid” refers to a polymer with repeating units resulting from ring-opening polymerization of L-lactide monomers or direct polymerization of L-lactic acids.

As used herein, “poly-D-lactic acid” refers to a polymer with repeating units resulting from ring-opening polymerization of D-lactide monomers or direct polymerization of D-lactic acids.

As used herein, “steroisomers” refer to mirror enantiomers that have the same chemical and structural formula and sequence of bonded atoms, but that differ only in the 3-dimensional orientations of their atoms in space.

As used herein, “organic-inorganic composite” refers to a composite including inorganic and organic materials that are covalently bonded.

As used herein, the term “grafted” refers to “being chemically bound” (e.g., covalently bound) onto a substrate or other polymers.

As used herein, the term “thermoplastic resin” refers to a resin having increasing flexibility at increasing temperatures.

According to an aspect of the present disclosure, a thermoplastic resin composition includes: a first thermoplastic polymer; and an organic-inorganic composite including a carbonaceous core and a second thermoplastic polymer grafted onto the carbonaceous core. The first and second thermoplastic polymers each have one or more structural units. A structural unit of the first thermoplastic polymer and a structural unit of the second thermoplastic polymer can have different structures from one another. In one embodiment, a structural unit of the first thermoplastic polymer and a structural unit of the second thermoplastic polymer are stereoisomers of one another.

When the second thermoplastic polymer grafted onto the carbonaceous core of the organic-inorganic composite has a structural unit that is a stereoisomer of the first thermoplastic polymer, which provides a matrix resin, the second thermoplastic polymer may form a stereocomplex with the first thermoplastic polymer. Without wishing to be bound by any particular theory or mechanism of action, it is believed this interaction between the first and second polymers improves the tensile characteristics of the thermoplastic resin composition. That is, the first thermoplastic polymer and the second thermoplastic polymer may be more strongly bound to each other, so that the thermoplastic resin composition may not be easily broken and separated by external impact.

For example, the first thermoplastic polymer and the second thermoplastic polymer may be thermoplastic polyester or polyamide. For example, the first thermoplastic polymer and the second thermoplastic polymer may be a polymerization product of an ester compound or an amide group-containing compound. For example, the first thermoplastic polymer and the second thermoplastic polymer may be each independently a polymerization product of lactic acid (or lactide), a polymerization product of a reaction product of an aliphatic dicarboxylic acid and a diol, a polymerization product of a reaction product of an aromatic dicarboxylic acid and a diol, a polymerization product of a reaction product of an alicyclic dicarboxylic acid and a diol, a polymerization product of a cyclic ester compound, a polymerization product of a linear amide compound, or A polymerization product of a cyclic amide compound.

The aliphatic dicarboxylic acid may be a compound represented by Formula 1.

HOOC—R₁—COOH <Formula 1>

In Formula 1, R₁ may be a covalent bond or a C1-C20 linear or branched alkylene group. For example, R₁ in Formula 1 may be a C1-C15 linear alkylene group, and in some embodiments, a C1-C10 linear alkylene group, and in some other embodiments, a C1-C6 linear alkylene group.

The aromatic dicarboxylic acid compound may be a compound represented by Formula 2.

HOOC-A₂-Ar₁-A₁-COOH <Formula 2>

In Formula 2, Ar₁ may be a C6-C20 arylene group or a C2-C20 heteroarylene group; and A₁ and A₂ may be each independently a covalent bond or a C1-C5 linear or branched alkylene group. For example, Ar₁ may be a phenylene group, a naphthalene group, or a pyridinylene group. At least one hydrogen of the arylene group and the heteroarylene group may be substituted with a halogen or a C1-C10 linear or branched alkyl group.

The alicyclic dicarboxylic acid compound may be a compound represented by Formula 3.

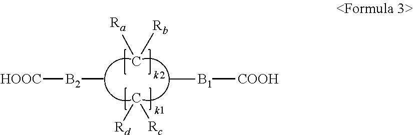

In Formula 3, Rₐ, R_{b}, R_{c}, and R_{d} may be each independently a hydrogen, a C1-C10 alkyl group, a C6-C20 aryl group, a C6-C10 cycloalkyl group, a C2-C10 alkenyl group, or a C2-C10 alkynyl group; B₁ and B₂ may be each independently a covalent bond or a C1-C5 alkylene group; and k1 and k2 may be each independently an integer of 1 to 20. For example, the alicyclic dicarboxylic acid compound may be at least one selected from oxalic acid, malonic acid, succinic acid, glutaric acid, adipic acid, pimelic acid, suberic acid, azelaic acid, sebasic acid, phthalic acid, isophthalic acid, terephthalic acid, hexahydrophthalic acid, hexahydroisophthalic acid, naphthalene dicarboxylic acid, and furane-2,5-dicarboxylic acid.

Non-limiting examples of the diol are ethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, neopentyl glycol, diethylene glycol, polyethylene glycol, polypropylene glycol, polytetramethylene ether glycol, 1,2-cyclohexanediol, 1,4-cyclohexanediol, 1,2-cyclohexanedimethanol, and 1,4-cyclohexaned imethanol.

The cyclic ester compound may be a C4-C20 lactone. For example, the cyclic ester compound may be butyrolactone, valerolactone, or caprolactone.

For example, the linear amide compound may have a structure represented by Formula 4.

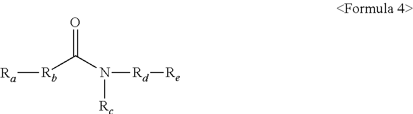

In Formula 4: Rₐ may be a hydrogen, a halogen, a C1-C10 alkyl group, or a carboxyl group; R_{b} and R_{d} may be each independently a C1-C10 alkylene group; R_{c} may be a hydrogen or a C1-C10 alkyl group; and Rₑ may be a hydrogen or an amine group.

For example, the linear amide compound may be a reaction product of dicarboxylic acid and diamine. For example, the linear amide compound may be a reaction product of adipic acid and hexamethylenediamine.

For example, the cyclic amide compound may have a structure represented by Formula 5.

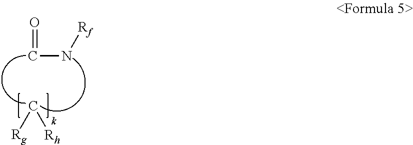

In Formula 5, R_{f} may be a hydrogen or a C1-C10 alkyl group; R_{g} and Rₕ may be each independently a C1-C10 alkyl group, a C6-C20 aryl group, a C6-C10 cycloalkyl group, a C2-C10 alkenyl group, or a C2-C10 alkynyl group; and k may be an integer of 2 to 20.

For example, the cyclic amide group-including compound may be a C3-C20 lactam. For example, the cyclic amide group-including compound may be propiolactam, butyrolactam, valerolactam, or caprolactam.

For example, the first thermoplastic polymer may be a poly-L-lactic acid.

For example, a poly-L-lactic acid used as the first thermoplastic polymer, which serves as a matrix resin in the thermoplastic resin composition, may be an aliphatic polyester including a repeating unit represented by Formula 6.

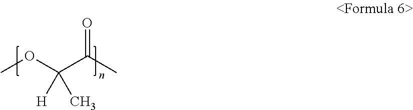

The poly-L-lactic acid may have an acidity of about 50 meq/kg or less, but is not limited thereto. When the acidity of the poly-L-lactic acid is about 50 meq/kg or less, the thermoplastic resin composition may be provided with further improved physical characteristics. For example, the poly-L-lactic acid may have an acidity of about 1 meq/Kg to about 50 meq/Kg, and in some embodiments, about 1 meg/Kg to about 30 meq/Kg, and in some other embodiments, about 1 meq/Kg to about 10 meq/Kg, and in still other embodiments, about 2 meq/Kg to about 5 meq/Kg.

For example, the poly-L-lactic acid may have a weight average molecular weight of about 10,000 Daltons to about 500,000 Daltons, and in some embodiments, about 100,000 Daltons to about 300,000 Daltons. When the poly-L-lactic acid has a weight average molecular weight of less than 10,000 Daltons, the thermoplastic resin composition may have deteriorated physical characteristics. When the poly-L-lactic acid has a weight average molecular weight of larger than 500,000 Daltons, it may be difficult to process the polymer. As a result of gel permeation chromatography (GPC) analysis, a weight-average molecular weight of the polu-L-lactic acid (PLLA) can be determined. The GPC analysis can be performed using polystyrene as a standard and tetrahydrofuran as a solvent.

The poly-L-lactic acid may have an optical purity of about 90% or greater. For example, the poly-L-lactic) acid may have an optical purity of about 93% or greater, and in some embodiments, about 95% or greater, and in some other embodiments, about 97% or greater. When the poly-L-lactic acid has an optical density of less than 90%, the physical characteristics of the poly-L-lactic acid may be deteriorated.

The second thermoplastic polymer may be at least one selected from poly-D-lactic acid, polycaprolactone, polycarprolactam (Nylon-6), Nylon-12, and polyglycolide.

The second thermoplastic polymer may have a number average molecular weight of about 500 g/mol to about 50,000 g/mol. For example, the second thermoplastic polymer may have a number average molecular weight of about 600 g/mol to about 50,000 g/mol, and in some embodiments, about 10,000 g/mol to about 30,000 g/mol, and in some other embodiments, about 15,000 g/mol to about 25,000 g/mol. When the second thermoplastic polymer has a number average molecular weight within these ranges, the tensile characteristics of the thermoplastic resin composition may be improved. When the number average molecular weight of the second thermoplastic polymer is too low, it may be difficult for the second thermoplastic polymer to form a strong stereocomplex with the first thermoplastic polymer as a matrix resin, thus deteriorating the tensile strength of the thermoplastic resin composition. On the other hand, when the number average molecular weight of the second thermoplastic polymer is too high, it may be difficult to graft the second thermoplastic polymer onto the carbonaceous core, and the amount of the carbonaceous core may become relatively low.

The second thermoplastic polymer may have a polydispersity index (PDI, Mw/Mn) of 2 or less. For example, the second thermoplastic polymer may have a PDI of 1 to 2. When the second thermoplastic polymer has a PDI within these ranges, the thermoplastic resin composition may have further improved tensile characteristics.

The second thermoplastic polymer may have a peak thermal decomposition temperature in the range of about 270° C. to 330° C., and in some embodiments, about 270° C. to about 290° C., as measured by thermogravimetric analysis (TGA). When the second thermoplastic polymer has a peak within these thermal decomposition temperature ranges, the thermoplastic resin composition including the second thermoplastic polymer may have improved tensile characteristics. The peak in these thermal decomposition temperature ranges indicates a peak temperature showing a maximum value in a first derivative graph of weight loss curve with respect to temperature.

The carbonaceous core of the thermoplastic resin composition may be a carbonaceous nanostructure. A nanostructure refers to a nano-sized structure having a shape, for example, nanorod, nanosphere, nanofiber, nanobelt, or nano-polyhedron. For example, the carbonaceous nanostructure for the carbonaceous core may be a carbon nanotube (CNT), a carbon nanosphere (C₆₀), a carbon nanofiber, a carbon nanobelt, a carbon nanorod, a carbon nano-polyhedron, or a carbon nanosheet.

For example, the carbonaceous nanostructure may be a 2-dimensional carbonaceous nanostructure. A 2-dimensional carbonaceous nanostructure refers to a nanostructure whose size is defined primarily by two dimensions, i.e., width and length, with a negligible third dimension, i.e., a size of the third dimension is less than 1/100 of that of the other two dimensions. For example, the 2-dimensional nanostructure for the carbonaceous core of the thermoplastic resin composition may be a planar (e.g., plate shaped) nanostructure, for example, graphene.

For example, the carbonaceous nanostructure may be a graphene oxide as a hydrophilic carbonaceous material. The graphene oxide may be obtained by exfoliation of graphene from graphite oxide. The graphene oxide may include a hydrophilic group such as a hydroxyl group, a carboxyl group, or the like on a surface thereof, wherein the hydrophilic group may serve as an initiator in grafting the second thermoplastic polymer onto the carbonaceous core. The graphene oxide may further include water bound to the hydrophilic group thereof.

The amount of the hydrophilic group including water in the graphene oxide may be in a range of about 1 wt % to about 50 wt % based on a total weight of the graphene oxide. For example, the amount of the hydrophilic group including water in the graphene oxide may be in a range of about 1 wt % to about 30 wt %, and in some embodiments, about 1 wt % to about 20 wt %, and in some other embodiments, about 1 wt % to about 15 wt %, each based on the total weight of the graphene oxide. When a graphene oxide including a hydrophilic group within these amount ranges is used in the organic-inorganic composite according to an embodiment of the present disclosure, the thermoplastic resin composition may have improved tensile characteristics.

In some embodiments, the amount of the second thermoplastic polymer may be in a range of about 5 wt % to about 50 wt % base on a total weight of the organic-inorganic composite of the thermoplastic resin composition. For example, the amount (i.e., graft density) of the second thermoplastic polymer grafted onto the graphene oxide may be in a range of about 6 wt % to about 47 wt %, and in some embodiments, about 7 wt % to about 45 wt %, each based on the total weight of the organic-inorganic composite. When the amount of the second thermoplastic polymer in the organic-inorganic composite is within these ranges, the thermoplastic resin composition using the organic-inorganic composite may have improved tensile characteristics.

For example, the amount of the first thermoplastic polymer in the thermoplastic resin composition may be in a range of about 97 wt % to about 99.99 wt %, and the amount of the organic-inorganic composite in the thermoplastic resin composition may be in a range of about 0.01 wt % to about 3 wt %, each based on a total weight of the thermoplastic resin composition. In some embodiments, the amount of the first thermoplastic polymer may be in a range of about 98 wt % to about 99.99 wt %, and the amount of the organic-inorganic composite may be in a range of about 0.01 wt % to about 2 wt %, each based on the total weight of the thermoplastic resin composition. In some other embodiments, the amount of the first thermoplastic polymer may be in a range of about 99 wt % to about 99.95 wt %, and the amount of the organic-inorganic composite may be in a range of about 0.05 wt % to about 1 wt %, each based on the total weight of the thermoplastic resin composition. In still other embodiments, the amount of the first thermoplastic polymer may be in a range of about 99.2 wt % to about 99.9 wt %, and the amount of the organic-inorganic composite may be in a range of about 0.1 wt % to about 0.8 wt %, each based on the total weight of the thermoplastic resin composition. In other embodiments, the amount of the first thermoplastic polymer may be in a range of about 99.5 wt % to about 99.9 wt %, and the amount of the organic-inorganic composite may be in a range of about 0.1 wt % to about 0.5 wt %, each based on the total weight of the thermoplastic resin composition. When the amount of the organic-inorganic composite is within these ranges, the thermoplastic resin composition may have improved tensile characteristics. When the amount of the organic-inorganic composite is too high, a strain improvement effect may be negligible. When the amount of the organic-inorganic composite is too high, the tensile strength of the thermoplastic resin composition may be reduced.

The thermoplastic resin composition may further include a third thermoplastic polymer, in addition to the second thermoplastic polymer that is included in the organic-inorganic composite. This may further improve the tensile characteristics of the thermoplastic resin composition. For example, this third thermoplastic polymer may be poly-D-lactic acid. The added poly-D-lactic acid may form a stereocomplex with poly-L-lactic acid used as the matrix resin, and thus may further improve the tensile characteristics of the thermoplastic resin composition. For example, the amount of the third thermoplastic polymer may be in a range of about 0.01 part to about 3 parts by weight based on 100 parts by weight of the thermoplastic resin composition including the organic-inorganic composite. For example, the amount of the third thermoplastic polymer may be in a range of about 0.01 part to about 2 parts by weight, and in some embodiments, about 0.01 part to about 1 part by weight, each based on 100 parts by weight of the thermoplastic resin composition including the organic-inorganic composite.

The thermoplastic resin composition may be in a liquid or solid state. The thermoplastic resin composition may be a composition before molding into a final product or may be a final molded article via molding, a film, or textile. These molded article, film, and textile may be formed in any shape by appropriate conventional methods used in the art.

The thermoplastic resin composition may further include an additive that is commonly used in conventional resin compositions.

Non-limiting examples of the additive are a filler, a terminal blocking agent, a metal deactivator, an antioxidant, a thermal stabilizer, a UV absorber, a lubricant, a tackifier, a plasticizer, a crosslinking agent, a viscosity adjusting agent, an antistatic agent, a flavoring agent, a dispersing agent, and a polymerization inhibitor. These additives may be added within a range not deteriorating physical characteristics of the thermoplastic resin composition.

For example, the thermoplastic resin composition may further include a filler. For example, the filler may be an inorganic filler such as talc, wollastonite, mica, clay, montmorillonite, smectite, kaolin, zeolite (aluminosilicate), or an anhydrous amorphous aluminum silicate obtained by acidic and thermal treatment of zeolite. When the thermoplastic resin composition includes a filler, the amount of the filler may be in a range of about 1 wt % to about 20 wt % based on the total weight of the thermoplastic resin composition to maintain the impact resistance of a final molded article.

For example, the thermoplastic resin composition may include a carbodiimide compound, such as a polycarbodiimide compound or a monocarbodiimide compound. These carbodiimide compounds may react with some or all of terminal carboxyl groups of polylactic acid resin, blocking side reactions such as hydrolysis, thus improving the water resistance of a molded article including the thermoplastic resin composition. Thus, a molded article including the thermoplastic resin composition may have improved durability under high-temperature and high-humidity conditions.

Examples of the polycarbodiimide compound are poly(4,4′-diphenylmethane carbodiimide), poly(4,440 -dicyclohexylmethane carbodiimide), poly(1,3,5-tridiisopropylbenzene)polycarbodiimide, poly(1,3,5-tridiisopropylbenzene, and 1,5-diisopropylbenzene)polycarbodiimide. For example, the monocarbodiimide compound may be N,N′-di-2,6-diisopropylphenylcarbodiimide.

The amount of the carbodiimide compound may be in a range of about 0.1 wt % to about 3 wt % based on a total weight of the thermoplastic resin composition. When the amount of the carbodiimide compound is less than 0.1 wt %, the durability improvement in a molded article may be insignificant. When the amount of the carbodiimide compound is larger than 3 wt %, a molded article may have weaken mechanical strength.

The thermoplastic resin composition may include a stabilizer or a colorant to stabilize the molecular weight or color of the composition article during molding. Non-limiting examples of the stabilizer are a phosphorus stabilizer, a hindered phenolic stabilizer, a UV absorber, a thermal stability, and an antistatic agent.

For example, the phosphorus stabilizer may be phosphorous acid, phosphoric acid, phosphonic acid, and esters thereof (a phosphite compound, a phosphate compound, a phosphonite compound, a phosphonate compound, or the like), and a third-grade phosphine.

For example, a stabilizer including a phosphonite compound as a main component may be Sandostab P-EPQ (available from Clariant), Irgafos P-EPQ (available from CIBA SPECIALTY CHEMICALS), or the like.

For example, a stabilizer including a phosphite compound as a main compound may be PEP-8 (available from ASAHI DENKA KOGYO KK), JPP681S (available from Tohoku Chemical Industry Incorporated Co.), PEP-24G (available from ASAHI DENKA KOGYO KK), Alkanox P-24 (available from Great Lakes), Ultranox P626 (available from GE Specialty Chemicals), Doverphos S-9432 (available from Dover Chemical), Irgaofos126, 126 FF (available from CIBA SPECIALTY CHEMICALS), PEP-36 (available from ASAHI DENKA KOGYO KK), PEP-45 (available from ASAHI DENKA KOGYO KK), or Doverphos S-9228 (available from Dover Chemical).

For example, the hindered phenolic stabilizer (antioxidant) may be a general compound used in conventional resins. For example, the hindered phenolic stabilizer may be 3,9-bis[2-{3-(3-t-butyl-4-hydroxy-5-methylphenyl)propionyloxy}-1,1-dimethylethyl]-2,4,8,10-tetraoxaspiro[5,5]undecane, but is not limited thereto. Any hindered phenolic compound available in the art as an oxidation stability for a thermoplastic resin composition may be used.

The amounts of the phosphorus stabilizer and the hindered phenolic antioxidant may be each in a range of about 0.005 wt % to about 1 wt % based on a total weight of the thermoplastic resin composition.

For example, the thermoplastic resin composition may include a UV absorber. The inclusion of a UV absorber in the thermoplastic resin composition may suppress deterioration in weather resistance of a molded article caused by a rubber component or a flame retardant. Examples of the UV absorber are benzophenone-based UV absorbers; benzotriazole-based UV absorbers; hydroxyphenyltriazine-based UV absorbers; cyclic iminoester-based UV absorbers; and cyanoacrylate-based UV absorbers. The amount of the UV absorber may be in a range of about 0.01 wt % to about 2 wt % based on a total weight of the thermoplastic resin composition.

For example, the thermoplastic resin composition may include a colorant such as a dye or a pigment to provide various colors to a molded article.

For example, the thermoplastic resin composition may include an antistatic agent to provide an antistatic characteristic to a molded article.

The thermoplastic resin composition may further include, in addition to the above-listed additives, other thermoplastic resins, a fluidity modifier, an antimicrobial agent, a dispersing agent such as a liquid paraffin, a photocatalytic contaminant removing agent, an infra-red (IR) absorbent, and a photochromic agent.

The thermoplastic resin composition including the organic-inorganic composite may have a tensile strength at yield of about 20 MPa or greater. When the thermoplastic resin composition has a tensile strength at yield of about 20 MPa or greater, a molded article made therefrom may have improved tensile characteristics.

The thermoplastic resin composition including the organic-inorganic composite may have a strain of about 20% or greater. For example, the thermoplastic resin composition including the organic-inorganic composite may have a strain of about 100% or greater, and in some embodiments, about 150% or greater, and in some other embodiments, about 200% or greater, and in still other embodiments, about 250% or greater, and in yet other embodiments, about 300% or greater. When the thermoplastic resin composition has a high strain of about 20% or greater, a molded article made therefrom may have improved tensile characteristics. As used herein, a strain refers to a strain at break point.

According to another aspect of the present disclosure, there is provided a molded article made of a thermoplastic resin composition according to any of the above-described embodiments.

The thermoplastic resin composition may be obtained by melt-compounding components thereof by using any of a variety of extruders, a banbury mixer, a kneader, a continuous kneader, or a roll. In the melt-compounding of the components, the components may be added simultaneously at one time or may be added in installments. In some embodiments, the thermoplastic resin composition may be obtained by separately dissolving the components in solvents, mixing the resulting solutions, and removing the solvent. The resulting thermoplastic resin composition may be formed into a molded article by using a known molding process, for example, extrusion molding, press molding, calendar molding, T-die extrusion molding, hollow profile sheet extrusion molding, foam sheet extrusion molding, inflation molding, lamination molding, vacuum molding, profile extrusion molding, or a combination of these methods.

When a mixing-kneading extruder or a mixer-kneader such as a banbury mixer is connected to a molder such as a calendar molder, T-die extrusion molder, or inflation moldering, a molded article may be formed at the same time with the preparation of the thermoplastic resin composition, without earlier preparation of the thermoplastic resin composition.

A molded article formed using the thermoplastic resin composition may be used for various uses without limitation. For example, the molded article may be used for medical uses, for example, as a vascular graft, a cell carrier, a drug carrier, or a gene carrier. The molded article may also be used as interior and exterior material for various general products, for example, for home appliances, communications devices, and industrial equipments. The molded article may also be used in the field of products for general uses, including cases, such as a relay case, a wafer case, a reticle case, and a mask case; trays, including a liquid crystal tray, a chip tray, a hard disk tray, a CCD tray, an IC tray, an organic EL tray, an optical pickup tray, and a LED tray; carriers such as an IC carrier; a polarizing film, a light guide plate, protective films for various lenses, mat sheets for use in cutting polarizing films, sheets used for such as partition plates in a clean room, or films; antistatic bags for vending machine inner members, liquid crystal panels, hard disks, or plasma panels; plastic corrugated fiberboards, carrier cases for liquid crystal panels, liquid crystal cells, or plasma panels; and other carrier related members for various parts.

According to another aspect of the present disclosure, a method of preparing a thermoplastic resin composition according to any of the above-described embodiments includes: mixing graphene oxide and D-lactide in the presence of a catalyst to prepare an organic-inorganic composite; and mixing the organic-inorganic composite and poly-L-lactic acid.

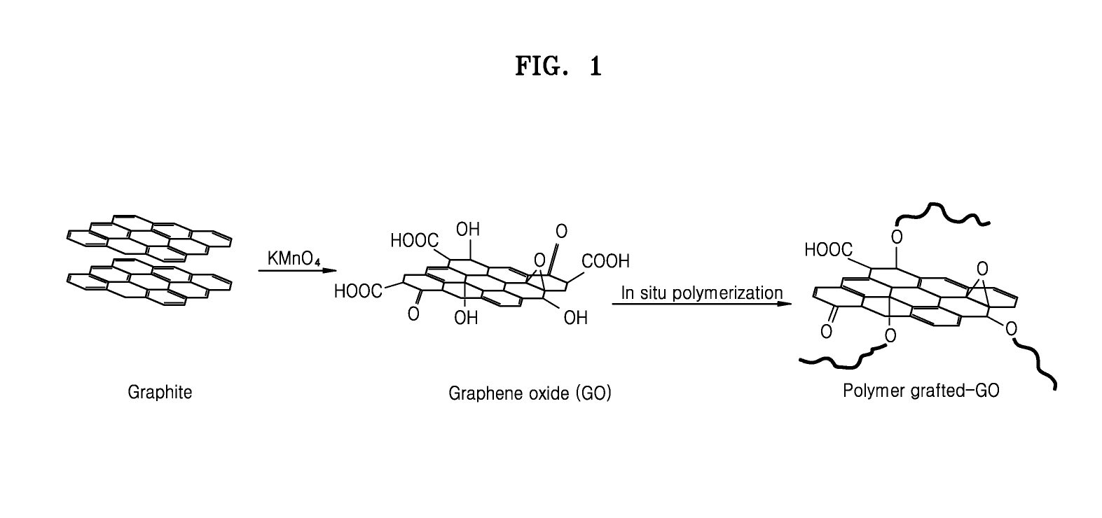

The method of preparing a thermoplastic resin composition will be described in greater detail with reference to FIG. 1, which is a schematic view illustrating preparing an organic-inorganic composite according to an embodiment of the present disclosure.

First, graphite may be put into contact with strong acid to form a graphite oxide by oxidation, the graphite oxide including a hydrophilic group introduced between graphene layers of the graphite, followed by, for example, sonication to obtain graphene oxide (GO) including graphene layers exfoliated from the graphite oxide. For example, a graphene oxide with hydrophilic groups such as a hydroxyl group (—OH), a carboxyl group (—COOH), and the like, bound to a carbonaceous surface sequentially as illustrated in FIG. 1 may be obtained. Subsequently, the graphene oxide may be mixed with D-lactide in the presence of a polymerization catalyst such as tin (II) 2-ethylhexanoate (Sn(Oct)₂) to graft D-lactide onto the graphene oxide, thus obtaining an organic-inorganic composite including poly-D-lactide grafted onto the graphene oxide, wherein the hydrophilic group such as a hydroxyl group on the graphene oxide may serve as an initiator for the grafting.

Next, the organic-inorganic composite may be mixed with poly-L-lactic acid resin to prepare a thermoplastic resin composition. This mixing process may be performed by either melt-blending or solution-blending. In solution-blending, the organic-inorganic composite and poly-L-lactic acid may be added to an organic solvent such as toluene, tetrahydrofuran, or chloroform in a predetermined ratio and dissolved, followed by removing the solvent by heating under a reduced pressure to obtain the thermoplastic resin composition. In melt-blending, the organic-inorganic composite and poly-L-lactic acid may be mixed using a mechanical agitator such as a kneading machine or a single-or twin-screw extruder at a temperature higher than or equal to the melting point of poly-L-lactic acid to obtain the thermoplastic resin composition.

In the method of preparing the thermoplastic resin composition, the amount of the hydrophilic group bound to the surface of the graphene oxide may be in a range of about 1 wt % to about 70 wt % based on a total weight of the graphene oxide. For example, the amount of the hydrophilic group including water in the graphene oxide may be in a range of about 10 wt % to about 60 wt %, and in some embodiments, about 20 wt % to about 50 wt %, and in some other embodiments, about 1 wt % to about 15 wt %, each based on the total weight of the graphene oxide. When a graphene oxide including a hydrophilic group within these amount ranges is used to prepare an organic-inorganic composite, a thermoplastic resin composition including the organic-inorganic composite may have improved tensile characteristics.

In the method of preparing the thermoplastic resin composition, the amount of the graphene oxide on which poly-D-lactic acid is grafted may be in a range of about 0.1 part to about 5 parts by weight based on 100 parts by weight of the poly-L-lactic acid. For example, the amount of the graphene oxide on which poly-D-lactic acid is grafted may be in a range of about 0.1 parts to about 4 parts by weight based on 100 parts by weight of the poly-L-lactic acid. For example, the amount of the graphene oxide on which poly-D-lactic acid is grafted may be in a range of about 0.1 part to about 3 parts by weight based on 100 parts by weight of the poly-L-lactic acid. When the amount of the graphene oxide is within this range, the thermoplastic resin composition may have improved tensile characteristics. When the amount of the graphene oxide is too low, the tensile characteristic improvement effect may be reduced. When the amount of the graphene oxide is too high, a stain improvement effect may be reduced.

Provided is a method of preparing a thermoplastic resin composition, the method comprising combining a first thermoplastic polymer with an organic-inorganic composite particle, wherein the organic-inorganic composite particle comprises a carbonaceous core and a second thermoplastic polymer grafted onto the carbonaceous core.

Provided is a method of making a molded article, the method comprising molding a thermoplastic resin composition into a desired shape.

One or more embodiments of the present disclosure will now be described in detail with reference to the following examples. However, these examples are only for illustrative purposes and are not intended to limit the scope of the one or more embodiments of the present disclosure.

### (Preparation of Graphene Oxide)

### PREPARATION EXAMPLE 1

### Graphene Oxide (GO) with a Low Degree of Oxidation

3 g of graphite was added to 100 mL of sulfuric acid, and then the temperature was maintained at about 0° C. for about 30 minutes, followed by adding 2.5 g of sodium nitrate (NaNO₃) thereto and stirring at about 0° C. for about 30 minutes for reaction. Subsequently, 5 g of potassium permanganate (KMnO₄) was added to the resulting reaction solution, and stirred at a low temperature for about 30 minutes for reaction and then at room temperature for about 12 hours for further reaction. When the color of the reaction solution was changed into greenish black with proceeding of the reaction, the oxidation reaction was terminated, followed by adding 300 mL of distilled (DI) water and leaving for about 1 hour. Subsequently, after adding further 50 mL of DI water and then 6 mL of hydrogen peroxide (H₂O₂, 30 wt %) thereto, the resulting reaction solution was reacted for about 1 hour. After termination of the oxidation reaction, the reaction solution was left for a while to remove the supernatant from the reaction solution, followed by adding DI water to the resulting reaction solution and centrifugation to precipitate graphite oxide. After removing the supernatant, DI water was added thereto to purify the graphite oxide, followed by filtration with a membrane filter to separate the graphite oxide, which was then vacuum dried to obtain graphite oxide powder including, at least partially, graphene oxide. The resulting graphite oxide powder was analyzed under a nitrogen atmosphere by thermogravimetric analysis (TGA). As a result, a remaining weight percent at 500° C. was about 70%. The amount ratio of carbon to oxygen was about 4:1 or greater, as analyzed by X-ray photoelectron spectroscopy (XPS) under monochromatic Al—Kα radiation (hv=1486.6 eV).

### PREPARATION EXAMPLE 2

### Graphene Oxide with a High Degree of Oxidation

A graphene oxide was prepared in the same manner as in Preparation Example 1, except that 15 g of potassium permanganate (KMnO₄) was added, and stirred at a low temperature for about 30 minutes for reaction and then at room temperature for about 24 hours for further reaction. As a result of the TGA, a remaining weight percent at 500° C. was about 50%. The amount ratio of carbon to oxygen analyzed by XPS was about 3:1 or less.

### (Preparation of Organic-Inorganic Composite)

### PREPARATION EXAMPLE 3

### Polv-D-Lactide (Mn=600)-Grafted Graphene Oxide (PDLA-g-GO)

0.1 g of the graphite oxide powder of Preparation Example 1 was put into 25 mL of anhydrous dimethyl formamide (DMF) in a 250-ml flask equipped with a stirrer, a heater, a condenser, and an evacuator under a nitrogen atmosphere, and then subjected to sonication for at least 30 minutes to obtain a dispersion of graphene oxide resulting from exfoliation of the graphite oxide. Next, 5 g of purified D-lactide (DLD) was added thereto, followed by increasing the temperature to about 140° C. while stirring. Next, 5 mg of tin (II) 2-ethylhexanoate (Sn(Oct)₂) as a catalyst was added thereto, followed by increasing the temperature to about 190° C. and reacting for about 20 hours. The resulting reaction product was put into about 10 times of volume of cold methanol to obtain a gray solid, which was then dissolved in chloroform to obtain a dispersion. This dispersion was filtered to selectively collect poly-D-lactide (PDLA)-grafted graphene oxide (PDLA-g-GO), followed by drying at about 40° C. and a reduced pressure of about 10 Torr for about 24 hours to obtain an organic-inorganic composite.

The PLDA had a number average molecular weight (Mn) of about 600 g/mol, as analyzed by gel permeation chromatography (GPC), a weight average molecular weight (Mw) of about 1,030 g/mol, and a polydispersity index (PDI) of about 1.72.

The amount (i.e., graft density) of the PLDA grafted onto the graphene oxide in the organic-inorganic composite was about 7 wt %, as analyzed by TGA.

### PREPARATION EXAMPLE 4

### PDLA (Mn=20,000)-g-GO

An organic-inorganic composite was prepared in the same manner as in Preparation Example 3, except that the graphene oxide of Preparation Example 2, instead of the graphene oxide of Preparation Example 1, was used.

The PDLA had a number average molecular weight (Mn) of about 20,000 g/mol, a weight average molecular weight (Mw) of about 32,800 g/mol, and a polydispersity index (PDI) of about 1.64.

The amount (i.e., graft density) of the PLDA grafted onto the graphene oxide in the organic-inorganic composite was about 45 wt %, as analyzed by TGA.

### COMPARATIVE PREPARATION EXAMPLE 1

### Polv-L-Lactic Acid (PLLA) (Mn=10,000)-g-GO

An organic-inorganic composite was prepared in the same manner as in Preparation Example 3, except that 5 g of L-lactide and the graphene oxide of Preparation Example 2, instead of 5 g of D-lactide and the graphene oxide of Preparation Example 1, were used.

The PLDA had a number average molecular weight (Mn) of about 10,000 g/mol, a weight average molecular weight (Mw) of about 16,400 g/mol, and a polydispersity index (PDI) of about 1.64.

The amount (i.e., graft density) of the PLDA grafted onto the graphene oxide in the organic-inorganic composite was about 20 wt %, as analyzed by TGA.

### COMPARATIVE PREPARATION EXAMPLE 2

### PDLA-Grafted Graphite

An organic-inorganic composite was prepared in the same manner as in Preparation Example 3, except that bare graphite, instead of the graphite oxide of Preparation Example 1, was used.

The amount (i.e., graft density) of the PLDA grafted onto the graphite in the organic-inorganic composite was about 1wt %, as analyzed by TGA.

### (Preparation of Thermoplastic Resin Composition)

### EXAMPLE 1

### PLLA+PDLA (Mn=600)-q-GO (about 0.2wt % of Organic-Inorganic Composite and a Graft Density of 7%)

1 g of poly-L-lactic acid (PLLA, 2002D grade, available from NatureWorks) and 2 mg of the organic-inorganic composite of Preparation Example 3 (PDLA (Mn=600 g/mol)-g-GO) were added to 20 mL of methylene chloride (MC) and sufficiently dissolved by sonication at room temperature for at least 30 minutes or longer to prepare a mixed solution. This mixed solution was poured to spread on a glass plate (10 cm×10 cm), and dried at room temperature for about 12 hours or longer and then further in a vacuum oven at about 60 torr and less than 10 torr for more than a day, followed by separating a resulting thermoplastic resin composition film from the glass plate. The thermoplastic resin composition film after the removal of the solvent had a thickness of about 70 μm to about 100 μm.

### EXAMPLE 2

### PLLA+PDLA (Mn=20,000)-g-GO (˜0.2%, Graft Density of 45%)

A thermoplastic resin composition was prepared in the same manner as in Example 1, except that 2 mg of the organic-inorganic composite of Preparation Example 4 (PDLA (Mn=20,000 g/mol)-g-GO), instead of 2 mg of the organic-inorganic composite of Preparation Example 3, was used.

### EXAMPLE 3

### PLLA+PDLA (Mn=20,000)-g-GO (˜0.05%, Graft Density of 45%)

A thermoplastic resin composition was prepared in the same manner as in Example 1, except that 0.5 mg of the organic-inorganic composite of Preparation Example 4 (PDLA (Mn=20,000 g/mol)-g-GO), instead of 2 mg of the organic-inorganic composite of Preparation Example 3, was used.

### EXAMPLE 4

### PLLA+PDLA (Mn=20,000)-g-GO (˜1%, Graft Density of 45%)

A thermoplastic resin composition was prepared in the same manner as in Example 1, except that 10 mg of the organic-inorganic composite of Preparation Example 4 (PDLA (Mn=20,000 g/mol)-g-GO), instead of 2 mg of the organic-inorganic composite of Preparation Example 3, was used.

### COMPARATIVE EXAMPLE 1

### PLLA Alone

A thermoplastic resin composition was prepared in the same manner as in Example 1, except that polylactic acid (poly-L-lactic acid) (PLLA, NatureWorks 2002D) was used alone.

### COMPARATIVE EXAMPLE 2

### PLLA+PDLA (˜0.2%)

A thermoplastic resin composition was prepared in the same manner as in Example 1, except that 0.2 part by weight of poly-D-lactic acid (PDLA, Mn=20,000) based on 100 parts by weight of poly-L-lactic acid (PLLA, NatureWorks 2002D) was used instead of the organic-inorganic composite of Preparation Example 3.

### COMPARATIVE EXAMPLE 3

### PLLA+PDLA (˜0.1%)+GO (˜0.1%)

A thermoplastic resin composition was prepared in the same manner as in Example 1, except that a mixture of 0.1 part by weight of the graphene oxide of Preparation Example 2 and 0.1 part by weight of poly-D-lactic acid (PDLA, Mn=20,000), each based on 100 parts by weight of poly-L-lactic acid (PLLA, NatureWorks 2002D), was used instead of the organic-inorganic composite of Preparation Example 3.

### COMPARATIVE EXAMPLE 4

### PLLA+PLLA-q-GO (˜0.2%)

A thermoplastic resin composition was prepared in the same manner as in Example 1, except that 0.2 part by weight of the organic-inorganic composite of Comparative Preparation Example 1, instead of 0.2 part by weight of the organic-inorganic composite of Preparation Example 3, was used

### EVALUATION EXAMPLE 1

### Thermogravimetric Analysis (TGA)

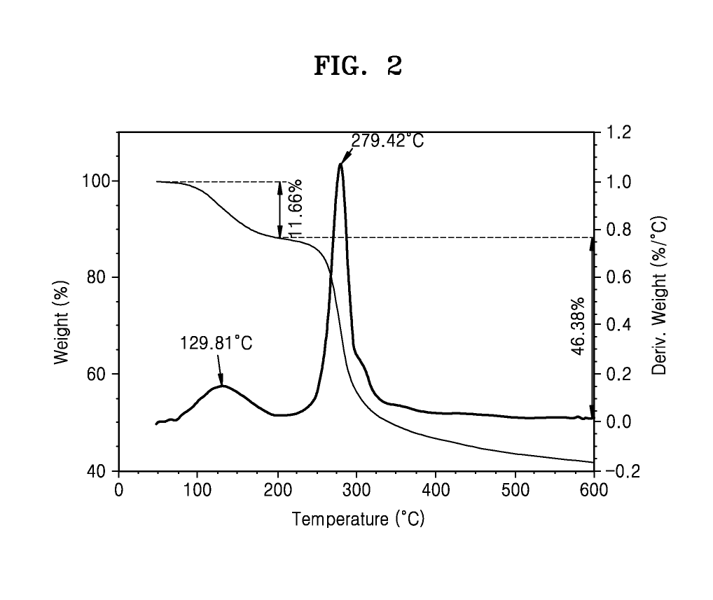

Thermogravimetric analysis (TGA) was performed using a thermogravimetric analyzer (TA Instrument Discovery series) at a temperature increase rate of about 10° C./min in a temperature range from room temperature to about 600° C. under a nitrogen atmosphere. The results of TGA on the organic-inorganic composite of Preparation Example 4 (PDLA-g-GO) are shown in FIG. 2.

Referring to FIG. 2, a weight loss of about 11.66% occurred in a temperature range of about 100° C. to about 200° C. This weight loss is attributed to the remaining moisture of the sample and the dehydration and thermal decomposition of hydrophilic groups such as a hydroxyl group (—OH) present on the surface of the graphene oxide. A weight loss of about 46.38% occurring in a temperature range of about 200° C. to about 600° C. is attributed to the thermal decomposition of the grafted poly-D-lactic acid. A thermal decomposition peak of poly-D-lactic acid was at a temperature of about 279° C.

### EVALUATION EXAMPLE 2

### X-ray Photoelectron Spectroscopy (XPS)

The amount ratio of carbon to oxygen (C/O) in graphene oxide was measured by X-ray photoelectron spectroscopy (XPS) using a Kratos AXIS X-ray photoelectron spectrometer (available from Kratos) under monochromatic Al—Kα radiation (hv=1486.6 eV).

Unoxidized graphite had a C/O ratio of about 95 or greater. The graphene oxide of Preparation Example 1 with a low degree of surface oxidation had a C/O ratio of about 4 or greater, and the graphene oxide of Preparation Example 2 with a high degree of surface oxidation had a C/O ratio of about 3 or less.

### EVALUATION EXAMPLE 3

### Tensile Characteristic Evaluation

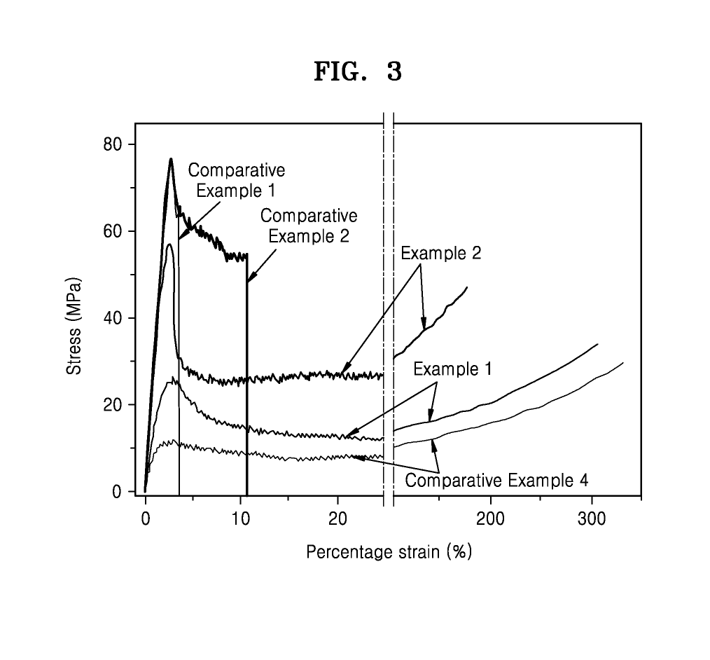

Tensile strengths and strains in the thermoplastic resin composition films (Width (W)=3.18±0.03 mm, Parallel length (L)=9.53±0.08 mm, Gauge length (G)=7.62±0.02 mm, Radius of curvature (R)=12.7±0.08 mm, and Thickness (T)=70˜100 micron) of Examples 1 to 4 and Comparative Examples 1 to 4 were measured using a tensile tester (universal testing machine (UTM), LS1SC, available from LLOUD Instruments) according to ASTM D638 conditions (Type V specimens dog-bone shape) at a gauge length of about 15 mm and a crosshead speed of about 10 mm/min. Some of the evaluation results are shown in Table 1 and FIG. 3.

TABLE 1

| | Tensile strength | Tensile strength | Strain |
|---|---|---|---|
| Example | at yield [MPa] | at break [MPa] | [%] |
| Example 1 | 26 | 34 | 300 |
| PLLA/0.6K PDLA-g-GO | | | |
| 0.2% | | | |
| Example 2 | 58 | 50 | 175 |
| PLLA/20K PDLA-g-GO | | | |
| 0.2% | | | |
| Example 3 | 44 | 18 | 23 |
| PLLA/20K PDLA-g-GO | | | |
| 0.05% | | | |
| Example 4 | 35 | 23 | 180 |
| PLLA/20K PDLA-g- | | | |
| GO 1% | | | |
| Comparative Example 1 | 78 | 63 | 7 |
| PLLA alone | | | |
| Comparative Example 2 | 78 | 54 | 11 |
| PLLA/20K PDLA 0.2% | | | |
| Comparative Example 3 | 76 | 50 | 9 |
| PLLA/20K PDLA 0.1%, | | | |
| GO 0.1% | | | |
| Comparative Example 4 | 12 | 31 | 320 |
| PLLA/10K PLLA-g-GO | | | |
| 0.2% | | | |

Referring to Table 1 and FIG. 3, the thermoplastic resin compositions of Examples 1 to 4 were found to have a markedly improved strain, compared to the thermoplastic resin compositions of Comparative Examples 1 to 3 and have a good tensile strength at yield of about 26 or greater.

The thermoplastic resin compositions of Examples 1, 2, and 4 were found to have a improved tensile strength at yield, compared to the thermoplastic resin composition of Comparative Example 4 including PLLA-grafted graphene oxide as an organic-inorganic composite, and have a strain of about 175% or greater.

In the thermoplastic resin compositions of Examples 1 to 4, the tensile strength at yield was increased with the increasing molecular weight of poly-D-lactide.

As described above, according to the one or more of the above embodiments of the present disclosure, a thermoplastic resin composition may include a matrix resin and an organic-inorganic composite including a polymer-grafted carbonaceous nanostructured core, the grafted polymer being a stereoisomer of the matrix resin, and thus may have improved tensile characteristics.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present disclosure have been described with reference to the figures, it will be understood by those of ordinary skill in the art that various changes in form and details may be made therein without departing from the spirit and scope of the present disclosure as defined by the following claims.

It should be understood that the exemplary embodiments described herein should be considered in a descriptive sense only and not for purposes of limitation. Descriptions of features or aspects within each embodiment should typically be considered as available for other similar features or aspects in other embodiments.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A thermoplastic resin composition comprising:
a first thermoplastic polymer; and
an organic-inorganic composite comprising a carbonaceous core and a second thermoplastic polymer grafted onto the carbonaceous core,
wherein a structural unit of the first thermoplastic polymer and a structural unit of the second thermoplastic polymer are stereoisomers or have different structures.

2. The thermoplastic resin composition of claim 1, wherein at least one of the first thermoplastic polymer and the second thermoplastic polymer is polylactic acid.

3. The thermoplastic resin composition of claim 1, wherein the first thermoplastic polymer is poly-L-lactic acid.

4. The thermoplastic resin composition of claim 1, wherein the second thermoplastic polymer is poly-D-lactic acid, polycaprolactone, polycarprolactam (Nylon-6), Nylon-12, polyglycolide, or a combination thereof.

5. The thermoplastic resin composition of claim 1, wherein the second thermoplastic polymer has a number average molecular weight of about 500 g/mol to about 50,000 g/mol.

6. The thermoplastic resin composition of claim 1, wherein the second thermoplastic polymer has a polydispersity index (PDI) of 2 or less.

7. The thermoplastic resin composition of claim 1, wherein the second thermoplastic polymer has a thermal decomposition peak in a temperature range of about 270° C. to about 330° C., as measured by thermogravimetric analysis (TGA).

8. The thermoplastic resin composition of claim 1, wherein the carbonaceous core is a carbonaceous nanostructure.

9. The thermoplastic resin composition of claim 8, wherein the carbonaceous nanostructure is a planar carbonaceous nanostructure.

10. The thermoplastic resin composition of claim 1, wherein the carbonaceous nanostructure is graphene oxide.

11. The thermoplastic resin composition of claim 1, wherein the amount of the second thermoplastic polymer is in a range of about 5 wt % to about 50 wt % based on a total weight of the organic-inorganic composite.

12. The thermoplastic resin composition of claim 1, wherein the amount of the first thermoplastic polymer is in a range of about 97 wt % to about 99.9 wt %, and the amount of the organic-inorganic composite is in a range of about 0.01 wt % to about 3 wt %, each based on a total weight of the thermoplastic resin composition.

13. The thermoplastic resin composition of claim 1, wherein the thermoplastic resin composition further comprises a third thermoplastic polymer.

14. The thermoplastic resin composition of claim 1, wherein the thermoplastic resin composition has a tensile strength at yield of about 20 MPa or greater.

15. The thermoplastic resin composition of claim 1, wherein the thermoplastic resin composition has a strain of about 100% or greater.

16. A molded article made of the thermoplastic resin composition of claim 1.

17. A method of preparing a thermoplastic resin composition, the method comprising:
mixing graphene oxide and D-lactide in the presence of a catalyst to prepare an organic-inorganic composite; and
mixing the organic-inorganic composite and a poly-L-lactic acid to form a thermoplastic resin composition.

18. The method of claim 17, wherein, in the step of the mixing of graphene oxide and D-lactide, the amount of the graphene oxide is in a range of about 0.1 part to about 5 parts by weight based on 100 parts by weight of the D-lactide.

19. The method of claim 17,wherein, in the step of the mixing of graphene oxide and D-lactide, the amount of the catalyst is in a range of about 0.01 part to about 1 part by weight based on 100 parts by weight of the D-lactide.

20. The method of claim 17, wherein, in the step of the mixing of graphene oxide and D-lactide, the graphene oxide comprises about 1 wt % to about 50 wt % of a hydrophilic group that is bound to a surface thereof, based on a total weight of the graphene oxide.
